(19) United States
(12) Patent Application Publication
(10) Pub. No.: US 2019/0299612 A1
(43) Pub. Date: Oct. 3, 2019

(54) Liquid Jetting Apparatus

(71) Applicant: Brother Kogyo Kabushiki Kaisha, Nagoya-shi (JP)

(72) Inventor: Toru Kakiuchi, Chita-gun (JP)

(21) Appl. No.: 16/261,944

(22) Filed: Jan. 30, 2019

(30) Foreign Application Priority Data
Mar. 30, 2018 (JP) 2018-068302

(51) Int. Cl. B41J 2/14

(52) U.S. Cl. CPC B41J 2/14201; B41J 2002/14491

(57) ABSTRACT

A liquid jetting apparatus includes: first pressure chambers aligned in a first direction; second pressure chambers aligned in the first direction and arranged at a distance from the first pressure chambers in a second direction orthogonal to the first direction; a first common channel extending in the first direction and communicating with the first pressure chambers; a second common channel extending in the first direction and communicating with the second pressure chambers; a third common channel extending in the first direction and communicating with the first and second pressure chambers; a substrate having a surface formed with the first and second pressure chambers and a space constituting at least part of the third common channel, vibration plates defining upper surfaces of the first and second pressure chambers, piezoelectric elements overlapping with the vibration plates, and a damper film defining an upper surface of the space.

### CROSS REFERENCE TO RELATED APPLICATION

The present application claims priority from Japanese Patent Application No. 2018-068302 filed on Mar. 30, 2018, the disclosure of which is incorporated herein by reference in its entirety.

### BACKGROUND

### Field of the Invention

The present invention relates to a liquid jetting apparatus configured to jet liquid from nozzles.

### Description of the Related Art

Conventionally, there is known an ink-jet type recording head including a channel substrate and two manifolds Which are provided outside the channel substrate and sealed with a sealing film being flexibly deformable. The channel substrate is formed with pressure generation chambers arranged in two rows and part of a circulation channel between the two rows of the pressure generation chambers.

### SUMMARY

In such an ink-jet type recording head, it is desirable to cause ink to flow stably by absorbing vibration of the ink. However, in the ink-jet type recording head having the above configuration, no consideration is made about the vibration of the ink flowing through the channel formed between the two rows of the pressure generation chambers.

An object of the present teaching is to improve the effect of absorbing vibration of liquid inside a common channel, in a liquid jetting apparatus having a substrate where two pressure chamber rows and at least part of the common channel, which is formed in communication with the respective pressure chambers in the two pressure chamber rows.

According to an aspect of the present teaching, there is provided a liquid jetting apparatus including: first pressure chambers aligned in a first direction; second pressure chambers aligned in the first direction and arranged at a distance from the first pressure chambers in a second direction orthogonal to the first direction; a first common channel extending in the first direction and communicating with the first pressure chambers; a second common channel extending in the first direction and communicating with the second pressure chambers; a third common channel extending in the first direction and communicating with the first pressure chambers and the second pressure chambers; a substrate having a surface parallel to the first direction and the second direction and being formed with the first pressure chambers, the second pressure chambers, and a space constituting at least part of the third common channel; vibration plates defining upper surfaces of the first pressure chambers and the second pressure chambers; piezoelectric elements formed to overlap with the vibration plates respectively; and a damper film defining an upper surface of the space, wherein the space is arranged between the first pressure chambers and the second pressure chambers in the second direction to extend in the first direction, and the damper film covers an opening, on an upper surface side of the substrate, forming the space.

According to the above configuration, the damper film covers the opening of the space constituting at least part of the third common channel at the upper surface side of the substrate. Therefore, it is possible to improve the effect of absorbing the vibration of the liquid inside the third common channel which communicates with the first pressure chambers aligned in the first direction and the second pressure chambers aligned in the first direction.

### BRIEF DESCRIPTION OF THE DRAWINGS

FIG. 1 is a schematic configuration diagram of a printer according to an embodiment of the present teaching.

FIG. 2 is a perspective view of an ink jet head of FIG. 1.

FIG. 3 is a perspective view of each substrate of the ink jet head of FIG. 1.

FIG. 4 is a cross-sectional view of the ink jet head of FIG. 2 along the line IV-IV.

FIG. 5 is a cross-sectional view of the ink jet head of FIG. 2 along the line V-V.

FIG. 6 is a cross-sectional view of the ink jet head of FIG. 2 along the line VI-VI.

FIG. 7 is a plan view of a substrate of FIG. 4.

FIG. 8 is a partially enlarged view of FIG. 4.

FIG. 9 is a perspective view of a support member of FIG. 4.

FIG. 10 is a plan view of a film of FIG. 4.

FIGS. 11A to 11E are cross-sectional views depicting a manufacturing process of the ink jet head of FIG. 1.

FIGS. 12A to 12D are other cross-sectional views depicting the manufacturing process of the ink jet head of FIG. 1.

### DESCRIPTION OF THE EMBODIMENT

Hereinbelow referring to the accompanying drawings, an embodiment of the present teaching will be explained.

<Overall Configuration of a Printer>

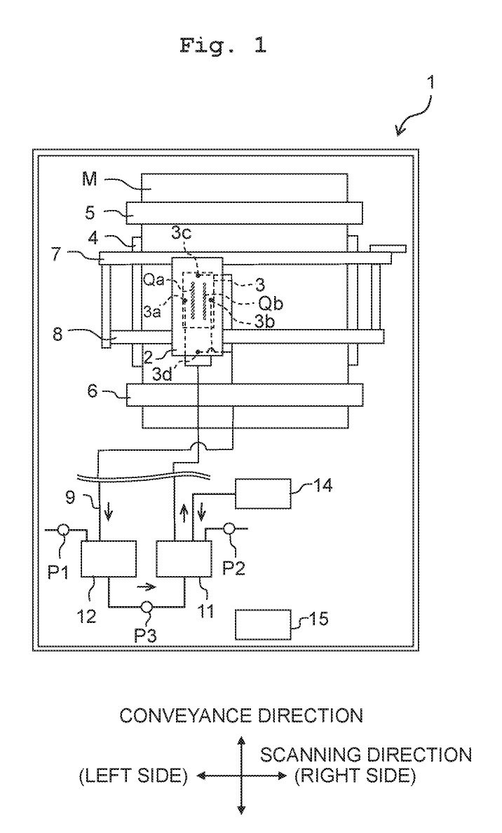

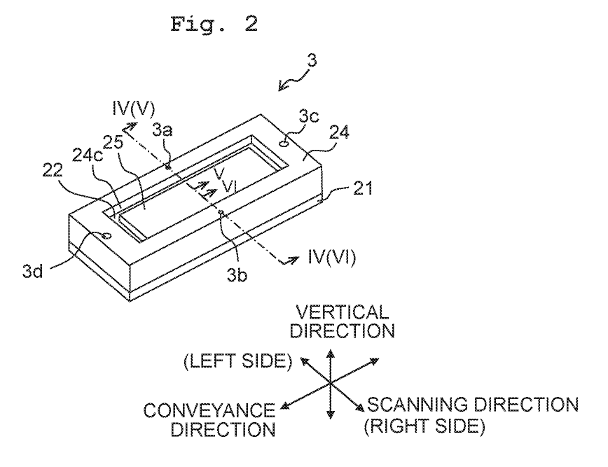

As depicted in FIGS. 1 and 2, a printer 1 includes a carriage 2, an ink jet head 3, a platen 4, conveyance rollers 5 and 6, a pressurizing tank 11, a negative pressure tank 12, air pumps P1 and P2, an ink pump P3, a tank 14, and a controller 15.

The carriage 2 is supported by two guide rails 7 and 8 extending in a scanning direction and, along the guide rails 7 and 8, moves reciprocatingly in the scanning direction together with the ink jet head 3. Hereinbelow, the right side of the page of FIG. 1 is defined as the right side in the scanning direction whereas the left side of the page is defined as the right side in the scanning direction.

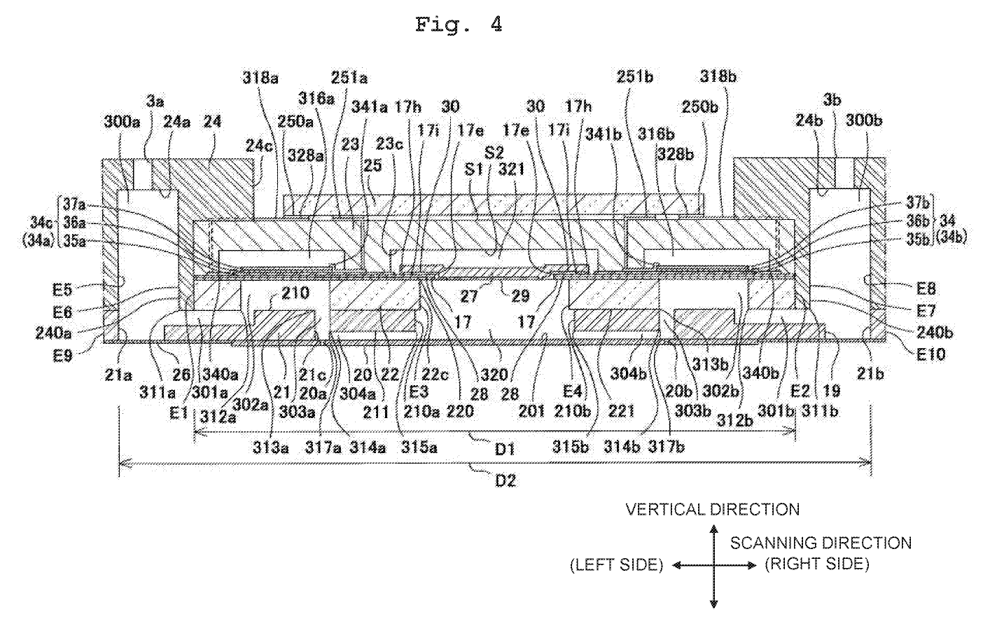

The ink jet head 3 is an exemplary liquid jetting apparatus, and is mounted on the carriage 2. The ink jet head 3 is, as will be described later on, provided with a total of 800 nozzles 20a and 20b (see FIG. 4) to jet ink as an example of liquid, two supply ports 3a and 3b, and two discharge ports 3c and 3d.

The supply ports 3a and 3b are connected with a pair of branched upstream ends of a pipe 9, while the discharge ports 3c and 3d are connected with a pair of branched downstream ends of the pipe 9. The pipe 9 is connected midway with the pressurizing tank 11, the negative pressure tank 12, and the ink pump P3. The ink is stored in the pressurizing tank. The pressurizing tank 11 is connected with the air pump P2 pressurizing the ink with air, and the supply tank 14 supplying the ink to the pressurizing tank 11. The pressurizing tank 11 is connected to such a part of the pipe 9 as close to the supply ports 3a and 3b. With the air pump P2 raising the pressure of the air in the pressurizing tank 11, the ink in the pressurizing tank 11 is pressurized to be supplied to the pipe 9.

The ink is also stored in the negative pressure tank 12. The negative pressure tank 12 is connected with the air pump P1 depressurizing the ink with air. The negative pressure tank 12 is connected to such a part of the pipe 9 as close to the discharge ports 3c and 3d. With the air pump P1 lowering the pressure of the air in the negative pressure tank 12, part of the ink flowing through the pipe 9 is sucked into the negative pressure tank 12.

The ink pump P3 is arranged at a part of the pipe 9 between the tanks 11 and 12. The ink pump P3 supplies the ink from the negative pressure tank 12 to the pressurizing tank 11. In the printer 1, along with driving of the pumps P1 to P3, the ink circulates inside the pipe 9 and the ink jet head 3.

The platen 4 is arranged to face the nozzles 20a and 20b of the ink jet head 3, and extends in the scanning direction and in a conveyance direction orthogonal to the scanning direction. A recording sheet M is placed on the platen 4. The conveyance rollers 5 and 6 convey the recording sheet M along the conveyance direction. The conveyance roller 5 is arranged on the upstream side from the carriage 2 in the conveyance direction while the conveyance roller 6 is arranged on the downstream side from the carriage 2 in the conveyance direction. The controller 15 individually controls the carriage 2, the pumps P1 to P3, the conveyance rollers 5 and 6, and a total of 800 piezoelectric elements 34a and 34b (see FIG. 4), respectively.

In the printer 1, the controller 15 controls the conveyance rollers 5 and 6 to convey the recording sheet M each time in the conveyance direction by a predetermined distance. The controller 15 controls the 800 piezoelectric elements 34a, 34b of the ink jet head 3 to jet the ink from the nozzles 20a and 20b while controlling the carriage 2 to move the same in the scanning direction. By virtue of this, printing is carried out on the recording sheet M.

<Ink Jet Head>

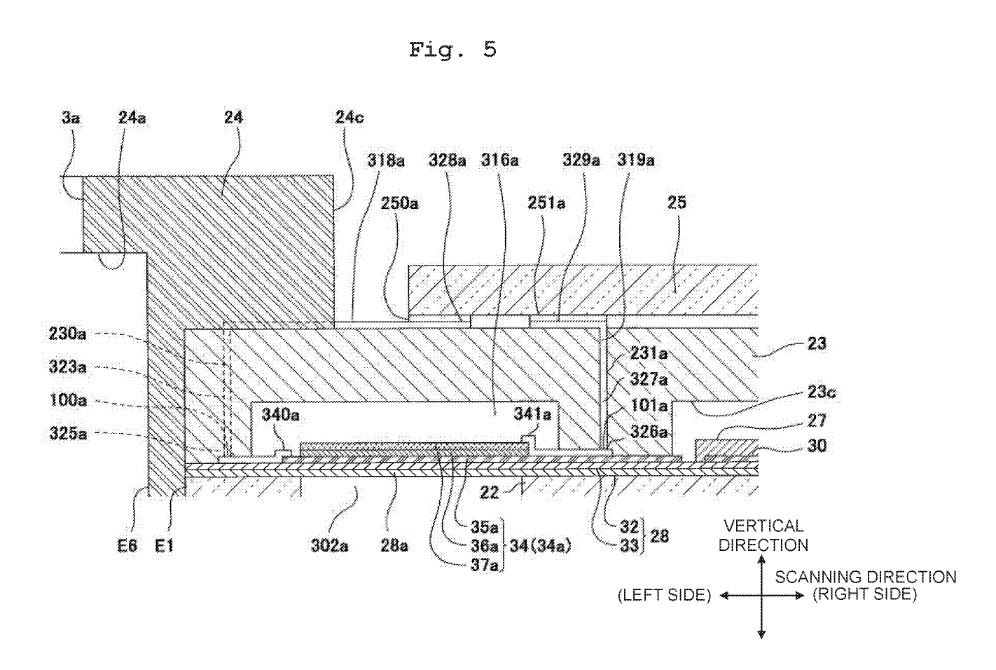

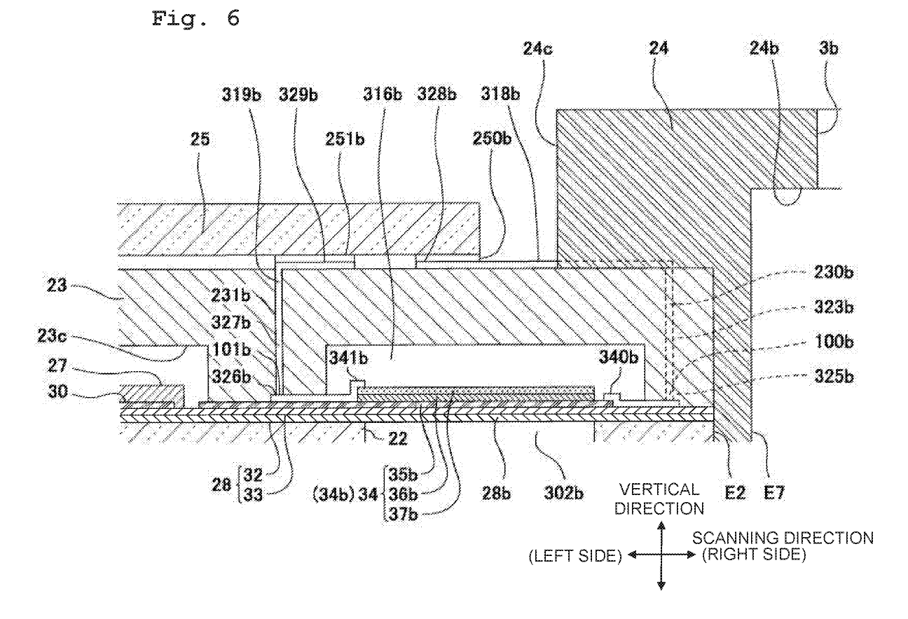

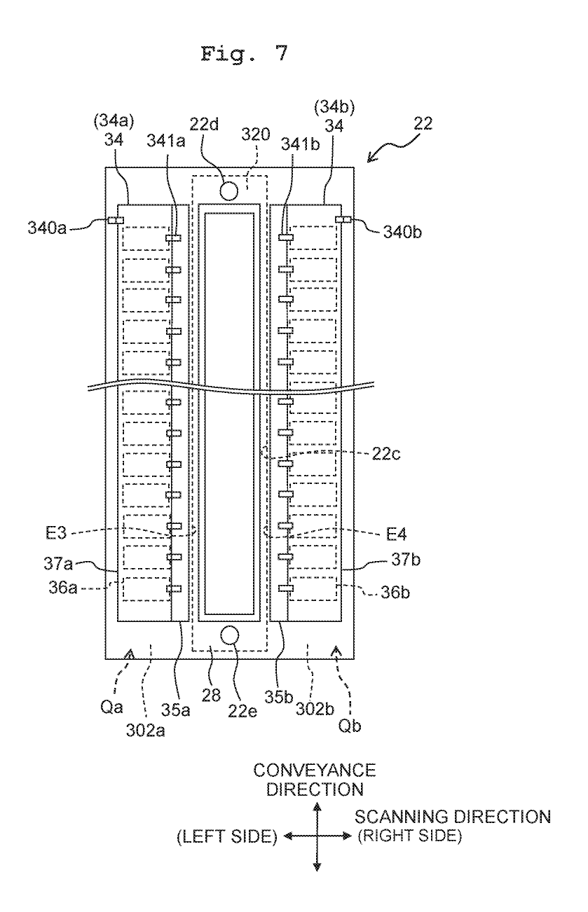

Referring to FIGS. 2-10, the ink jet head 3 of the present teaching will be explained. In FIGS. 5 and 6, a partial structure of wires 318a and 318b is depicted with broken lines. FIG. 7 depicts a surface, of a substrate 22, provided with the piezoelectric elements 34a and 34b and depicts positions of pressure chambers 302a, pressure chambers 302b and a channel 320 with broken lines. A direction perpendicular to the page of FIG. 7 is a vertical direction which will be described later on.

As depicted in FIGS. 2 to 4 and 8, the ink jet head 3 includes a nozzle substrate 20, a substrate 21, the substrate 22, a substrate 23, a channel member 24, an IC 25, damper films 26 and 27, a vibration plate 28, a support member 17, 400 films 29, a film 30, and the total of 800 piezoelectric elements 34a and 34b. The nozzle substrate 20, the substrate 21, the substrate 22, the substrate 23, and the IC 25 are arranged upwardly (in a direction away from the platen 4 along the thickness direction of the platen 4) in the above order to overlap with each other.

The ink jet head 3 is constructed by combining the nozzle substrate 20, the substrates 21 to 23, and the channel member 24. The ink jet head 3 is formed internally with the channel 300a, the channel 300b, the channel 320,400 communication channels 304a, 400 communication channels 304b, 400 pressure chambers 302a, 400 pressure chambers 302b, an operation space 316a, an operation space 316b, and a displacement space 321.

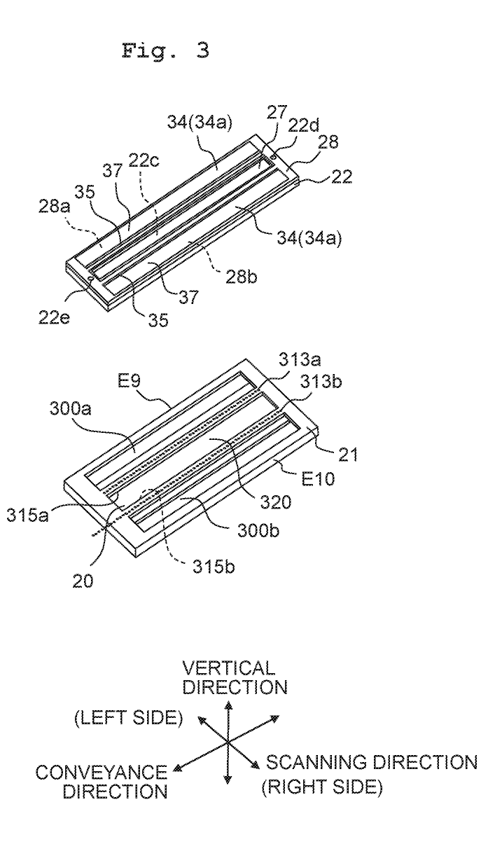

As depicted in FIG. 3, the channel 300a and the channel 300b are arranged at the two opposite sides of the ink jet head 3 in the scanning direction to interpose the channel 320. The channel 300a and the channel 300b are arranged to extend in the conveyance direction along the surface of the substrate 21, at an interval along the scanning direction.

The pressure chambers 302a and the communication channels 304a are arranged between the channel 300a and the channel 320, and the pressure chambers 302b and the communication channels 304b are arranged between the channel 300b and the channel 320. The channel 300a is connected to the channel 320 via the pressure chambers 302a and the communication channels 304a. The channel 300b is connected to the channel 320 via the pressure chambers 302b and the communication channels 304b. In the ink jet head 3, the ink flows from the channel 300a and the channel 300b toward the channel 320.

In particular, the nozzle substrate 20 is arranged to superimpose the surface of the substrate 21 at the side of the platen 4. The nozzle substrate 20 is, for example, formed of a silicon single crystal, a metal, or a resin. The nozzle substrate 20 is formed with the 400 nozzles 20a and the 400 nozzles 20b. The 400 nozzles 20a and the 400 nozzles 20b are formed to penetrate through the nozzle substrate 20 in the thickness direction. The 400 nozzles 20a align in the conveyance direction and the 400 nozzles 20b also align in the conveyance direction. The 400 nozzles 20a and the 400 nozzles 20b align in the scanning direction.

Between the nozzle substrate 20 and the substrate 22, the 400 communication channels 304a are formed to let the ink flow toward the channel 320 after passing through the pressure chambers 302a, while the 400 communication channels 304b are formed to let the ink flow toward the channel 320 after passing through the pressure chambers 302b. In this embodiment, the 400 communication channels 304a and the 400 communication channels 304b are formed between the nozzle substrate 20 and the substrate 21.

The 400 nozzles 20a are formed in midstream on the respective communication channels 304a to correspond individually to the 400 pressure chambers 302a and the 400 communication channels 304a. The respective communication channels 304a extend in the scanning direction to let the ink flow toward the channel 320 after passing through the corresponding pressure chambers 302a. The 400 nozzles 20b are formed in midstream on the respective communication channels 304b to correspond individually to the 400 pressure chambers 302b and the 400 communication channels 304b. The respective communication channels 304b extend in the scanning direction to let the ink flow toward the channel 320 after passing through the corresponding pressure chambers 302b.

Note that the respective nozzles 20a may be arranged to overlap with the corresponding pressure chambers 302a along the vertical direction orthogonal to the conveyance direction and to the scanning direction. Further, the respective nozzles 20b may be arranged to overlap with the pressure chambers 302b along the vertical direction.

As depicted in FIG. 3, the substrate 21 defines the channel 300a and the channel 300b. The substrate 21 may include a substrate 19 stacked on the surface of the substrate 21 at the other side than where the vibration plate 28 is arranged. The substrate 19 may be formed of silicon, for example. The substrate 19 may define at least part of the channel 300a and at least part of the channel 300b, respectively. The substrate 21 is sized larger than the nozzle substrate 20 along the scanning direction. The two opposite ends of the substrate 21 along the scanning direction extend from the two opposite ends of the nozzle substrate 20 toward the opposite side from the channel 320.

The channel 300a is arranged at the left side of the nozzle substrate 20 while the channel 300b is arranged at the right side of the nozzle substrate 20. The channel 300a is arranged at the left side of two aftermentioned pressure chamber rows Qa and Qb while the channel 300b is arranged at the right side of the two pressure chamber rows Qa and Qb. The channel 300a is a common channel extending along the conveyance direction and in communication with the 400 pressure chambers 302a. The channel 300b is a common channel extending along the conveyance direction and in communication with the 400 pressure chambers 302b.

The substrate 22 is arranged to superimpose the surface of the substrate 21 at the other side than the nozzle substrate 20. The substrate 22 has a surface parallel to the conveyance direction and to the scanning direction. The substrate 22 is formed of silicon, for example. The substrate 22 is formed with the 400 pressure chambers 302a, the 400 pressure chambers 302b, and a space 22c constituting at least part of the channel 320. Further, the substrate 22 is provided with the 400 piezoelectric elements 34a and the 400 piezoelectric elements 34b.

As depicted in FIGS. 4 and 7, the 400 pressure chambers 302a align along the conveyance direction, as viewed from the vertical direction, between the channel 300a and the channel 300b. The 400 pressure chambers 302b are arranged apart from the 400 pressure chambers 302a in the scanning direction to align in the conveyance direction. By virtue of this, the two pressure chamber rows Qa and Qb are formed.

The ink having passed through the channel 300a flows into the respective pressure chambers 302a forming the pressure chamber row Qa while the ink having passed through the channel 300b flows into the respective pressure chambers 302b forming the pressure chamber row Qb.

The channel 320 is arranged between the two pressure chamber rows Qa and Qb to extend in the conveyance direction. The ink having passed through the respective pressure chambers 302a and 302b flows into the channel 320. The channel 320 is formed by cutting in the substrate 22. The channel 320 extends along the conveyance direction. The channel 320 is a common channel in communication with the 400 pressure chambers 302a and the 400 pressure chambers 302b. The respective piezoelectric elements 34a apply jet pressure to the ink inside the pressure chambers 302a while the respective piezoelectric elements 34b apply jet pressure to the ink inside the pressure chambers 302b.

As depicted in FIG. 4, a channel 301a is provided between the channel 300a and the respective pressure chamber 302a to extend in the scanning direction. An opening 311a of the channel 301a at the side of the channel 300a is defined by a surface 210 of the substrate 21 at the side of the channel member 24 and a side surface 240a of the channel member 24 at the aftermentioned end E6. An opening 312a of the channel 301a at the side of the channel 320 is defined by a surface 221 of the substrate 22 at the side of the substrate 20 and the surface 210 of the substrate 21.

Further, a channel 303a is formed between the respective pressure chambers 302a and the corresponding communication channels 304a to extend in the vertical direction. An opening 313a of the channel 303a at the side of the substrate 22 is defined by the surface 210 of the substrate 21, and an opening 314a of the channel 303a at the side of the nozzle substrate 20 is defined by a surface 211 of the substrate 21 at the side of the nozzle substrate 20.

Further, the opening 314a is connected with an opening 317a of the corresponding communication channels 304a at the side of the pressure chamber 302a. The surface 211 of the substrate 21 defines the opening 317a. An opening 315a of the communication channels 304a at the side of the channel 320 is defined by a side surface 210a of the substrate 21 at the side of the channel 320, and a surface 201 of the nozzle substrate 20 at the side of the substrate 21.

Further, as depicted in FIG. 4, a channel 301b is provided between the channel 300b and the respective pressure chamber 302b to extend in the scanning direction. An opening 311b of the channel 301b at the side of the channel 300b is defined by the surface 210 of the substrate 21 and a side surface 240b of the channel member 24 at the aftermentioned end E7. An opening 312b of the channel 301b at the side of the channel 320 is defined by the surface 221 of the substrate 22 and the surface 210 of the substrate 21.

Further, a channel 303b is formed between the respective pressure chambers 302b and the corresponding communication channels 304b to extend in the vertical direction. An opening 313b of the channel 303b at the side of the substrate 22 is defined by the surface 210 of the substrate 21, and an opening 314b of the channel 303b at the side of the nozzle substrate 20 is defined by the surface 211 of the substrate 21 at the side of the nozzle substrate 20.

Further, the opening 314b is connected with an opening 317b of the corresponding communication channels 304b at the side of the pressure chamber 302b. The surface 211 of the substrate 21 defines the opening 317b. An opening 315b of the communication channels 304b at the side of the channel 320 is defined by a side surface 210b of the substrate 21 at the side of the channel 320, and the surface 201 of the nozzle substrate 20 at the side of the substrate 21.

Here, because the channels 301a and 303a and the communication channels 304a are smaller than the pressure chambers 302a in terms of channel cross-sectional area, they are larger than the pressure chambers 302a in terms of channel resistance. Likewise, because the channels 301b and 303b and the communication channels 304b are smaller than the pressure chambers 302b in terms of channel cross-sectional area, they are larger than the pressure chambers 302b in terms of channel resistance.

As depicted in FIGS. 2, 3 and 7, supply ports 3a and 3b and discharge ports 3c and 3d are formed in the channel member 24. At the upstream side of the substrate 22 along the conveyance direction, a through hole 22d is formed to penetrate therethrough in the thickness direction. The through hole 22d is in communication with the discharge port 3c and the channel 320 formed in the channel member 24. At the downstream side of the substrate 22 along the conveyance direction, a through hole 22e is formed to penetrate therethrough in the thickness direction. The through hole 22e is in communication with the discharge port 3d and the channel 320 formed in the channel member 24.

As depicted in FIG. 4, in the ink jet head 3, one channel 301a one pressure chamber 302a, one channel 303a, and one communication channel 304a are formed to correspond to one nozzle 20a, Further, one channel 301b, one pressure chamber 302b, one channel 303b, and one communication channel 304b are formed to correspond to one nozzle 20b.

As depicted in FIGS. 4 to 6, the substrate 22 is further provided with a vibration plate 28. The vibration plate 28 transmits the vibration generated by the respective piezoelectric elements 34a to the ink inside the corresponding pressure chambers 302a, and transmits the vibration generated by the respective piezoelectric elements 34b to the ink inside the corresponding pressure chambers 302b. It is possible to set the vibration plate 28 at an appropriate thickness which may be, for example, of a value not less than 1.5 μm and not more than 2.0 μm.

The vibration plate 28 blocks the upper surfaces of the 400 pressure chambers 302a and the 400 pressure chambers 302b. The vibration plate 28 includes elastic layers 32 and 33. The elastic layers 32 and 33 are formed of an inorganic material. The vibration plate 28 has 400 parts 28a overlapping with the 400 piezoelectric elements 34a and 400 parts 28b overlapping with the 400 piezoelectric elements 34b.

The elastic layer 32 is arranged on the surface of the substrate 22 at the other side than the nozzle substrate 20. The elastic layer 33 overlaps with the surface of the elastic layer 32. The vibration plate 28 is formed of a metallic oxide. For example, the elastic layer 32 is formed of SiO₂ (silicon dioxide). For example, the elastic layer 33 is formed of ZrO₂ (zirconium dioxide). The substrate 22 supports the piezoelectric elements 34a and 34b via the vibration plate 28.

The space 22c is arranged between the 400 pressure chambers 302a and the 400 pressure chambers 302b along the scanning direction, and extends along the conveyance direction. By virtue of this, at least part of the channel 320 (the upper part of the channel 320 in this embodiment) is positioned between the pressure chambers 302a and 302b.

Note that the channel 320 may have at least one of a part overlapping with the pressure chambers 302a along the vertical direction and a part overlapping with the pressure chambers 302b along the vertical direction. Further, the channel 320 may have at least one of a part overlapping with somewhere between the pressure chambers 302a and the channels 300a along the vertical direction and a part overlapping with somewhere between the pressure chambers 302b and the channels 300b along the vertical direction.

The substrate 23 is a wiring member connecting the total of 800 piezoelectric elements 34a and 34b and the IC 25. The substrate 23 has one wire 318a, one wire 318b, 400 wires 319a, and 400 wires 319b.

The substrate 23 in this embodiment has a surface S1 mounted with the IC 25, and a surface S2 at the other side than the surface S1. As depicted in FIGS. 4 to 6, the substrate 23 has, in particular, one through hole 230a, one through hole 230b, 400 through holes 231a, and 400 through holes 231b. Each of the through holes 230a, 230b, 231a and 231b penetrates through the substrate 23 from the surface S1 to the surface S2. The wire 318a is inserted in the through hole 230a, while the wire 318b is inserted in the through hole 230b. One wire 319a is inserted in each of the through holes 231a, while one wire 319b is inserted in each of the through holes 231b.

The wire 318a has a part 323a formed in the through hole 230a, a terminal 325a provided in a part facing the substrate 22, and a terminal 328a provided in a part facing the IC 25. The wires 319a. has a part 327a formed in the through holes 231a, a terminal 326a provided in a part facing the substrate 22, and a terminal 329a provided in a part facing the IC 25.

The wire 318b has a part 323b formed in the through hole 230b, a terminal 325b provided in a part facing the substrate 22, and a terminal 328b provided in a part facing the IC 25. The wires 319b has a part 327b formed in the through holes 231b, a terminal 326b provided in a part facing the substrate 22, and a terminal 329b provided in a part facing the IC 25. Each of the terminals 325a, 324b, 326a and 326b is formed on the surface of the substrate 22 at the other side than the nozzle substrate 20.

The parts 323a and 323b are pass-through electrode parts of the wires 318a and 318b, while the parts 327a and 327b are pass-through electrode parts of the wires 319a and 319b. Further, the surface S2 is formed with a recess 23c facing the damper film 27 along the vertical direction. Because the recess 23c is formed, the substrate 23 will not hinder the damper film 27 from deforming.

The substrate 23 is arranged to cover the piezoelectric elements 34a and 34b and the damper film 27. The substrate 23 is formed of, for example, silicon. The substrate 23 is formed with operation spaces 316a and 316b for the piezoelectric elements 34a and 34b, and a displacement space 321 for the damper film 27. The operation spaces 316a and 316b are formed in positions overlapping with the piezoelectric elements 34a and 34b while the displacement space 321 is formed in a position overlapping with the damper film 27.

The channel member 24 covers the periphery of the substrate 23 with the surface of the substrate 23 being exposed at the other side than the nozzle substrate 20. The channel member 24 is formed of, for example, a metal, a resin, or the like. The channel member 24 is formed with a through hole 24c penetrating therethrough along the vertical direction. The substrate 23 exposes its surface at the other side than the nozzle substrate 20 from the through hole 24c. The channel member 24 is combined with the substrate 21 on the outside of the substrate 23 in the scanning direction.

As depicted in FIG. 4, the substrate 21 is formed with two through holes 21a and 21b penetrating therethrough along the thickness direction. Two recesses 24a and 24b are formed in the surface of the channel member 24 facing the substrate 21. The through hole 21a and the recess 24a overlap in the vertical direction to form the channel 300a while the through hole 21b and the recess 24b overlap in the vertical direction to form the channel 300b. The channel 300a and the channel 300b extend respectively in the conveyance direction to interpose the channel 320 along the scanning direction.

The substrate 22 has the end E1 and the end E2 as its two ends in the scanning direction. The substrate 21 has the end E9 and the end E10 as its two ends in the scanning direction. The channel 300a has the end E5 and the end E6 as its two ends in the scanning direction. The channel 300b has the end E7 and the end E8 as its two ends in the scanning direction.

The ends E5 to E8 in this embodiment are arranged in the order of the end E5, the end E6, the end E7, and the end. E8, along the scanning direction from the end E9 toward the end E10. The distance D1 from the end E1 to the end E2 along the scanning direction is smaller than the distance D2 from the end E5 to the end E8 along the scanning direction.

The IC 25 is a driver IC driving the total of 800 piezoelectric elements 34a and 34b. The IC 25 is arranged inside the through hole 24c along the surface of the substrate 23 at the other side than the nozzle substrate 20. As depicted in FIGS. 4 to 6, the IC 25 has terminals 250a, 250b, 251a, and 251b.

One end of the wire 318a extends along the upper surface of the substrate 23, and a terminal 328a thereof is connected with the terminal 250a of the IC 25. The other end of the wire 318a extends in the vertical direction, and a terminal 325a thereof is connected with the terminals 340a of the piezoelectric elements 34a. The terminals 340a are connected with the common electrode 35a.

One end of the wires 319a extends along the upper surface of the substrate 23, and a terminal 329a thereof is connected with the terminal 251a. of the IC 25. The other end of the wires 319a extends in the vertical direction, and a terminal 326a thereof is connected with the terminals 341a of the piezoelectric elements 34a. The terminals 341a are connected with the individual electrodes 37a.

One end of the wire 318b extends along the upper surface of the substrate 23 and a terminal 328b thereof is connected with the terminal 250b of the IC 25. The other end of the wire 318b extends in the vertical direction, and a terminal 325b thereof is connected with the terminals 340b of the piezoelectric elements 34b. The terminals 340b are connected with the common electrode 35b.

One end of the wires 319b extends along the upper surface of the substrate 23, and a terminal 329b thereof is connected with the terminal 251b of the IC 25. The other end of the wires 319b extends in the vertical direction, and a terminal 326b thereof is connected with the terminals 341b of the piezoelectric elements 34b. The terminals 341b are connected with the individual electrodes 37b.

In this manner, the IC 25 is arranged on the upper surface of the substrate 23 and connected with the total of 800 piezoelectric elements 34a and 34b through the wires 318a, 318b, 319a and 319b. Therefore, members such as a flexible substrate and the like are not needed for connecting, for example, the piezoelectric elements 34a and 34b with the IC 25.

Here, the respective pressure chambers 302a, and the respective terminals 341a of the corresponding piezoelectric elements 34a are arranged between the end E1 and the space 22c along the scanning direction. Further, the respective pressure chambers 302b, and the respective terminals 341b of the corresponding piezoelectric elements 34b are arranged between the end E2 and the space 22c along the scanning direction.

In this embodiment, the respective terminals 341a are arranged between the 400 pressure chambers 302a and the space 22c along the scanning direction. Further, the respective terminals 340b are arranged between the 400 pressure chambers 302b and the space 22c along the scanning direction. Further, the respective terminals 341a and 341b may be arranged in positions overlapping with aftermentioned piezoelectric layers 36a and 36b.

As depicted in FIG. 4, the damper film 26 is provided on the substrate 21 to block the through hole 21a and the through hole 21b of the substrate 21. The damper film 26 absorbs the vibration of the ink inside the channel 300a and the channel 300b. The damper film 26 is a thin film made of polyphenylene sulfide (PPS) or stainless steel. For example, the damper film 26 is provided on the lower surface of the substrate 21.

The damper film 27 is provided on the substrate 22 to block an opening 220 of the substrate 22. The damper film 27 absorbs the vibration of the ink inside the channel 320. The damper film 27 is arranged on the upper surface of the substrate 22. The damper film 27 defines the space 22c at the side of the upper surface of the substrate 22. The damper film 27 restrains the ink flowing through the channel 320 from moving on the upper surface of the substrate 22 via the space 22c. As depicted in FIGS. 3 and 7, the damper film 27 has, for example, a rectangular contour with the conveyance direction as its longitudinal direction.

The damper film 27 in this embodiment is formed of a different material from the damper film 26. The damper film 27 is formed of a resin material. For example, the damper film 27 is formed of photoresist. Since the damper film 27 is formed of photoresist, it is possible to easily pattern the damper film 27 and/or to easily set a thickness for the same.

The damper film 27 is lower in elastic modulus than the elastic layers 32 and 33 of the vibration plate 28. Further, the damper film 27 is higher in toughness than the elastic layers 32 and 33 of the vibration plate 28. Note that the damper film 27 may be smaller in thickness than the piezoelectric layers 36a and 36b. In the ink jet head 3, the nozzle substrate 20 is arranged on the lower surface of the substrate 21. The channel 320 is defined by the substrate 22, the substrate 21, the nozzle substrate 20, the vibration plate 28, and the damper film 27.

The support member 17 is constructed from the same layer as the elastic layers 32 and 33 of the vibration plate 28. The support member 17 is interposed between the substrate 22 and the damper film 27 along the vertical direction to support the damper film 27. The support member 17 in this embodiment is formed continuous with the vibration plate 28. As depicted in FIG. 7, the support member 17 (in other words, the vibration plate 28) is formed with an opening which has a rectangular contour as viewed from the vertical direction and has a rectangular periphery on the inside. This opening is one end of the space 17d at the side of the substrate 23. The support member 17 may be formed discontinuous with the vibration plate 28 (in other words, separate from the vibration plate 28 in the scanning direction).

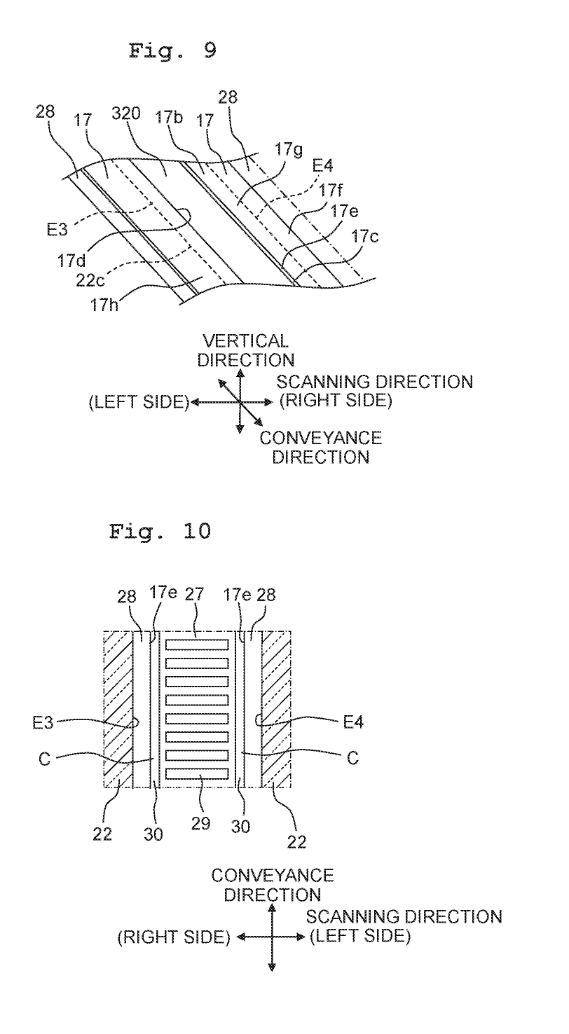

FIG. 9 has omitted the film 30 and the damper film 27. FIG. 10 depicts the surface of the damper film 27 at the side of the nozzle substrate 20.

As depicted in FIGS. 4 to 8, the space 22c of the substrate 22 has the end E3 and the end E4 as its two opposite ends along the scanning direction. The end E3 is arranged between the end E1 and the end E4 while the end E4 is arranged between the end E3 and the end E2. The support member 17 has a part 17h and a part 17i. The part 17h is arranged between the end E1 of the substrate 22 and the end E3 of the space 22c and between the end E2 of the substrate 22 and the end E4 of the space 22c along the scanning direction, and interposed between the damper film 27 and the substrate 22 along the vertical direction.

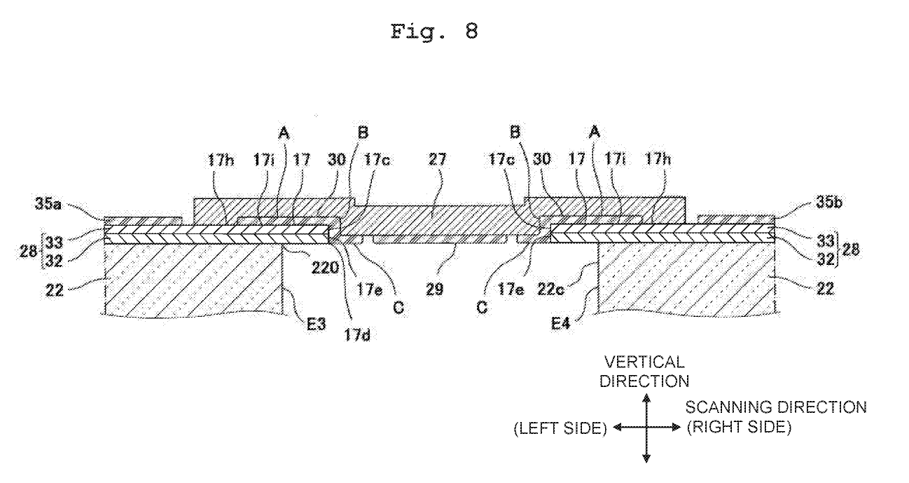

The part 17i projects from the part 17h on the left side of the page of FIG. 8 toward the end E4 of the space 22c, and projects from the part 17h on the right side of the page of FIG. 8 toward the end E3 of the space 22c. The part 17i has a side surface 17c positioned between the end E3 and the end E4 of the space.

Here, the ink jet head 3 includes a space 17d arranged inside the space 22c as viewed from the vertical direction. As depicted in FIG. 9, the support member 17 further has a peripheral portion 17e, a ring-like portion 17f, and an extending portion 17g. The peripheral portion 17e defines the space 17d. The ring-like portion 17f is arranged to enclose the space 22c as viewed from the vertical direction. The extending portion 17g extends from the ring-like portion 17f to the peripheral portion 17e.

It is possible to appropriately set a length for the extending portion 17g from the ring-like portion 17f to the peripheral portion 17e and, for example, to set a value not less than 10 μm and not more than 50 μm. Further, the damper film 27 may be formed of the same material as the damper film 26. Further, the damper film 27 may be formed of the same material as the vibration plate 28. In such a case, it is possible to use part of the vibration plate 28 overlapping with the channel 320 as the damper film 27.

The substrate 22 is further provided with a film 30. The film 30 prevents the damper film 27 from detachment. The film 30 is formed of the same material as the electrodes (the common electrodes 35a and 35b, for example) included respectively in the total of 800 piezoelectric elements 34a and 34b.

The film 30 has parts A to C. The part A is interposed between the upper surface of the part. 17i and the damper film 27. The part B is interposed between the side surface 17c of the support member 17 and the damper film 27.

The part C projects from the part B of the support member 17 on the left side toward the end E4 of the space 22c, and projects from the part B of the support member 17 on the right side toward the end E3 of the space 22c. The part C has an end arranged between the end E3 and the end E4 of the space 22c along the scanning direction. The damper film 27 is superimposed by the space 17d of the support member 17 via the film 30 and formed to fit in the space 17d of the support member 17.

Further, the part C of the film 30 extends from the side surface 17c of the support member 17 toward the center of the space 17d along the scanning direction. By virtue of this, the peripheral part of the damper film 27 is supported by the film 30 in the area overlapping with the space 22c of the damper film 27 along the vertical direction.

Here, when viewed from the conveyance direction, the film 30 covers the side surface 17c of the support member 17 along a gentle curve. By virtue of this, the damper film 27 with the attached film 30 is prevented from forming edges such that damage is prevented along with the vibration of the damper film 27. Further, the damper film 27 increases in the adhesion to the film 30, thereby preventing the damper film 27 from detachment.

The film 30 is formed of the same material as the common electrodes 35a and 35b. The film 30 may be formed of the same material as the individual electrodes 37a and 37b or of a different material from the electrodes 35a, 35b, 37a, and 37b.

As depicted in FIGS. 8 and 10, the film 29 is stacked on the surface of the damper film 27 facing the space 22c. The film 29 is a reinforcement member for reinforcing the damper film 27. The film 29 is formed of the same material as the electrodes included respectively in the total of 800 piezoelectric elements 34a and 34b. The film 29 is arranged to overlap with the damper film 27 positioned inside the space 17d of the support member 17. The film 29 is made of a metal. In this embodiment, 400 films 29 are arranged on the lower surface of the damper film 27 at intervals along the conveyance direction. The 400 films 29 are arranged on the lower surface of the damper film 27 at floating-island-like intervals.

It is possible to set an appropriate thickness for the films 29, for example, smaller than the thickness of the vibration plate 28. The films 29 are set to a value of thickness, for example, not less than 100 nm and not more than 200 nm.

The films 29 are made of, for example, the same material as the aftermentioned common electrodes 35a and 35b. The films 29 may be formed of the same material as the individual electrodes 37a and 37b or of a different material from the electrodes 35a, 35b, 37a, and 37b. Further, the number of films 29 may be another than 400. Further, the films 29 are not limited to the aforementioned shape but may be, for example, a grid-like shape expanding along the surface of the damper film 27.

By driving the pumps PI to P3, the ink supplied to the supply port 3a from the pipe 9 is supplied to the channel 300a while the ink supplied to the supply port 3b from the pipe 9 is supplied to the channel 300b. The ink supplied to the channel 300a flows through the channels 301a, the pressure chambers 302a, the channels 303a, the communication channels 304a, and the channel 320, in the above order. The ink supplied to the channel 300b flows through the channels 301b, the pressure chambers 302b, the channels 303b, the communication channels 304b, and the channel 320, in the above order. Part of the ink flowing through the communication channels 304a and 304b are jetted from the nozzles 20a and 20b.

Further, by driving the pumps P1 to P3, the ink passing through the channel 320 is discharged from the discharge ports 3c and 3d to the pipe 9. The ink discharged to the pipe 9 is returned to the negative pressure tank 12 through the pipe 9, and resupplied from the supply ports 3a and 3b to the channels 300a and 300b. By virtue of this, the ink circulates between the ink jet head 3 and the tanks 11 and 12.

Here, in order to jet the ink from the nozzles 20a and 20b, the vibration of the piezoelectric elements 34a and 34b is transmitted to the ink flowing through the pressure chambers 302a and 302b. This vibration may also be transmitted to the ink flowing through the respective channels 300a, 300b and 320. etc.

In regard to this aspect, in the ink jet head 3 according to this embodiment, the vibration transmitted to the ink flowing through the channel 300a and the channel 300b is absorbed with the damper film 26 undergoing elastic deformation along the vertical direction. Further, the vibration transmitted to the ink flowing through the channel 320 is absorbed with the damper film 27 undergoing elastic deformation along the vertical direction. With the damper film 26 and the damper film 27 deforming in this manner, the ink flowing inside the ink jet head 3 is restrained from pressure variation.

<Piezoelectric Elements>

As depicted in FIGS. 4 to 7, an actuator 34 is provided on the upper surface of the substrate 22. The actuator 34 is constructed from the total of two piezoelectric layers 36a and 36b, the total of two common electrodes 35a and 35b, the total of 800 individual electrodes 37a and 37b, and the one vibration plate 28.

The piezoelectric layers 36a and 36b expand in the conveyance direction and the scanning direction. The piezoelectric layers 36a and 36b are made of a piezoelectric material. The piezoelectric material may take, for example, lead zirconate titanate (PLT) as its primary material. The piezoelectric layers 36a and 36b are arranged in positions overlapping with the pressure chambers 302a and 302b of the substrate 22.

Further, the piezoelectric layers 36a and 36b may be constructed of two or more layers arranged to overlap with each other. These layers may include a layer(s) made of a piezoelectric material and a layer(s) made of another material than the piezoelectric material (for example, an insulating material such as a synthetic resin material or the like).

The common electrodes 35a and 35b are arranged between the vibration plate 28 and the piezoelectric layers 36a and 36b, to extend continuously across almost the entire area of the piezoelectric layers 36a and 36b. The common electrodes 35a and 35b are arranged at a distance from the film 30 along the scanning direction. The common electrodes 35a and 35b are maintained at the ground potential.

The individual electrodes 37a and 37b are arranged to overlap with the piezoelectric layers 36a and 36b and provided individually for the respective pressure chambers 302a and 302b. The common electrodes 35a and 35b and the individual electrodes 37a and 37b are made of a metallic material with a good conductivity such as platinum (Pt) or iridium (Ir). An insulating layer is arranged appropriately between the common electrodes 35a and 35b and the individual electrodes 37a and 37b to facilitate insulation.

As depicted in FIGS. 3, 4, and 7, when viewed from the vertical direction, the piezoelectric layers 36a and 36b and the common electrodes 35a and 35b have a belt-like plane shape with the conveyance direction as the longitudinal direction and with the scanning direction as the width direction. The common electrodes 35a and 35b are arranged at the two opposite sides of the damper film 27 along the scanning direction. Ends of the common electrodes 35a and 35b at one side along the scanning direction extend to a position as far as not to overlap with the pressure chambers 302a and 302b, and connect with the terminals 340a and 340b for connection with the IC 25.

The terminal 340a is connected with a terminal 325a of the wire 318a at a contact point 100a while the terminal 340b is connected with a terminal 325b of the wire 318b at a contact point 100. The contact points 100a and 100b are arranged not to overlap with the space 22c and the damper film 27 along the vertical direction, respectively.

When viewed from the vertical direction, the individual electrodes 37a and 37b have an approximately rectangular plane shape with the conveyance direction as the width direction and with the scanning direction as the longitudinal direction. The individual electrodes 37a and 37b are arranged to overlap with central portions of the corresponding pressure chambers 302a and 302b. The individual electrodes 37a and 37b have such ends on one side along the scanning direction as to extend to positions as far as not to overlap with the pressure chambers 302a and 302b, and connect with the terminals 341a and 341b for connection with the IC 25.

The terminal 341a is connected with a terminal 326a of the wire 319a at a contact point 101a, while the terminal 340b is connected with a terminal 326b of the wire 319b at a contact point 101b. The contact points 101a and 101b are arranged not to overlap with the space 22c and the damper film 27 along the vertical direction, respectively.

The individual electrodes 37a and 37b are individually set by the IC 25 to either the ground potential or a predetermined drive potential (20 V or so, for example). The common electrodes 35a and 35b, the individual electrodes 37a and 37b, and the respective parts of the piezoelectric layers 36a and 36b interposed between the individual electrodes 37a and 37b and the common electrodes 35a and 35b constitute the total of 800 piezoelectric elements 34a and 34b. The piezoelectric elements 34a and 34b function as active portions of the actuator 34 being polarized in the vertical direction.

The piezoelectric elements 34a and 34b apply a jet pressure to the ink in the pressure chambers 302a and 302b to jet the ink from the nozzles 20a and 20b. As depicted in FIG. 4, in the ink jet head 3, the total of 800 piezoelectric elements 34a and 34b are provided to correspond respectively to the total of 800 nozzles 20a and 20b. The total of 800 piezoelectric elements 34a and 34b are formed respectively to overlap with the vibration plate 28.

In particular, the piezoelectric elements 34a have the piezoelectric layer 36a, the common electrode 35a connected to one surface of the piezoelectric layer 36a, and the individual electrodes 37a connected to the other surface of the piezoelectric layer 36a. The piezoelectric elements 34b have the piezoelectric layer 36b, the common electrode 35b connected to one surface of the piezoelectric layer 36b, and the individual electrodes 37b connected to the other surface of the piezoelectric layer 36b. The common electrodes 35a and 35b and the individual electrodes 37a and 37b include metallic electrodes extending along the surface of the vibration plate 28. The metallic electrodes are the individual electrodes 37a and 37b in this embodiment.

When the piezoelectric elements 34a and 34b do not cause the ink to be jetted from the nozzles 20a and 20b (in a standby state), all of the individual electrodes 37a and 37b are maintained at the same ground potential as the common electrodes 35a and 35b. Further, when the piezoelectric elements 34a and 34b cause the ink to be jetted from certain nozzles 20a and 20b, the individual electrodes 37a and 37b (the two individual electrodes 37a and 37b in the two piezoelectric elements 34a and 34b depicted in FIG. 4) corresponding to the pressure chambers 302a and 302b connected to the certain nozzles 20a and 20b are switched to the predetermined drive potential.

Thereafter, an electric field parallel to the polarization direction is generated in the two active portions corresponding to the above individual electrodes 37a and 37b, such that the above piezoelectric elements 34a and 34b contract in a direction perpendicular to the polarization direction. By virtue of this, in the piezoelectric elements 34a and 34b, the parts overlapping with the pressure chambers 302a and 302b of the piezoelectric layers 36a and 36b along the vertical direction deform as a whole to project toward the pressure chambers 302a and 302b. As a result, the volumes of the pressure chambers 302a and 302b decrease such that the ink pressure in the pressure chambers 302a and 302b increases, thereby jetting the ink from the certain nozzles 20a and 20b. After the ink is jetted, the potential of the above individual electrodes 37a and 37h returns to the ground potential. By virtue of this, the piezoelectric layers 36a and 36b are restored to the state before the deformation.

As explained earlier on, according to the ink jet head 3, the damper film 27 blocks the opening 220 of the space 22c constituting at least part of the channel 320 at the side of the upper surface of the substrate 22. Hence, it is possible to improve the effect of absorbing the vibration of the ink inside the channel 320 in communication with the 400 pressure chambers 302a aligned in the conveyance direction, and with the 400 pressure chambers 302b aligned in the conveyance direction.

Further, in the ink jet head 3, the damper film 26 and the damper film 27 are provided as the damper films absorbing the ink vibration. Therefore, it is possible to increase the contact area of the damper film 26 and damper film 27 with the ink so as to improve the effect of absorbing the vibration transmitted to the ink. Further, because the damper film 27 is provided to absorb the vibration of the ink flowing through the channel 320 between the channel 300a and the channel 300b, it is possible to prevent the ink jet head 3 from increasing in the width in the scanning direction.

Further, because part of the channels 300a and 300b is formed in the other substrate 21 than the substrate 22 while the damper film 26 is provided on the substrate 21, it is possible to prevent the substrate 22 from decreasing in yield ratio. Hence, it is possible to suppress the production cost of the ink jet head 3. Further, by forming the damper film 27 of a resin material, it is possible to further improve the effect of absorbing the vibration of the ink flowing through the channel 320.

The substrate 22 supports the total of800 piezoelectric elements 34a and 34b via the vibration plate 28. The channel 320 is formed by cutting in the substrate 22. The damper film 27 is arranged to superimpose the upper surface of the vibration plate 28. Therefore, it is possible to arrange the total of 800 piezoelectric elements 34a and 34b and the damper film 27 in a compact manner, thereby facilitating conservation of the space for arranging the channel 320.

Further, because the ink jet head 3 is provided with the IC 25 arranged on the substrate 23 to drive the total of 800 piezoelectric elements 34a and 34b, it is possible to preferably restrain the ink jet head 3 from upsizing along the vertical direction.

Further, because the damper film 27 is arranged to superimpose the upper surface of the support member 17 to cover the space 17d, it is possible to preferably absorb the ink vibration in the channel 320 through the space 17d. Further, it is possible for the support member 17 to reliably support the damper film 27.

Further, the extending portion 17g of the support member 17 projects toward the center of the space 22c along the scanning direction beyond the ends E3 and E4 of the space 22c of the substrate 22, and the damper film 27 is supported by the extending portion 17g of the support member 17. Therefore, it is possible to lessen the flexure of the contact part of the damper film 27 with the support member 17. Hence, it is possible to relieve the stress from concentration on the contact part of the damper film 27 with the support member 17. Therefore, it is possible to stabilize the damper film 27 with the support member 17 while preventing the damper film 27 from damage.

Further, the damper film 27 is arranged to overlap with the support member 17 via the film 30 and formed to fit in the space 17d of the support member 17. Therefore, it is possible to preferably support the damper film 27 with the support member 17 while protecting the damper film 27 with the film 30 from the peripheral portion 17e of the support member 17.

Further, the film 30 is formed of the same material as the electrodes included respectively in the total of 800 piezoelectric elements 34a and 34b. Therefore, it is possible, in manufacturing, to form the electrodes and the film 30 with the same material at a low cost, while forming the electrodes and the film 30 effectively in the same process.

Further, the ink jet head 3 is provided with the film 29 being a reinforcing member. It is possible to stably use the damper film 27 for a long period of time due to the reinforcement of the damper film 27 with the film 29.

Further, the film 29 is formed of the same material as the electrodes included respectively in the total of 800 piezoelectric elements 34a and 34b. Therefore, it is possible, in manufacturing, to form the electrodes and the film 29 with the same material at a low cost, while forming the electrodes and the film 29 effectively in the same process.

Further, when the electrodes included respectively in the total of 800 piezoelectric elements 34a and 34b are formed of a metal such as Pt, Ir or the like, by forming the film 29 of the same material as the electrodes, it becomes easy to adjust the same to a small thickness. By virtue of this, if the film 29 is provided, then it is possible for the effect of absorbing the vibration by the damper film 27 to be less easily diminished by the rigidity of the film 29.

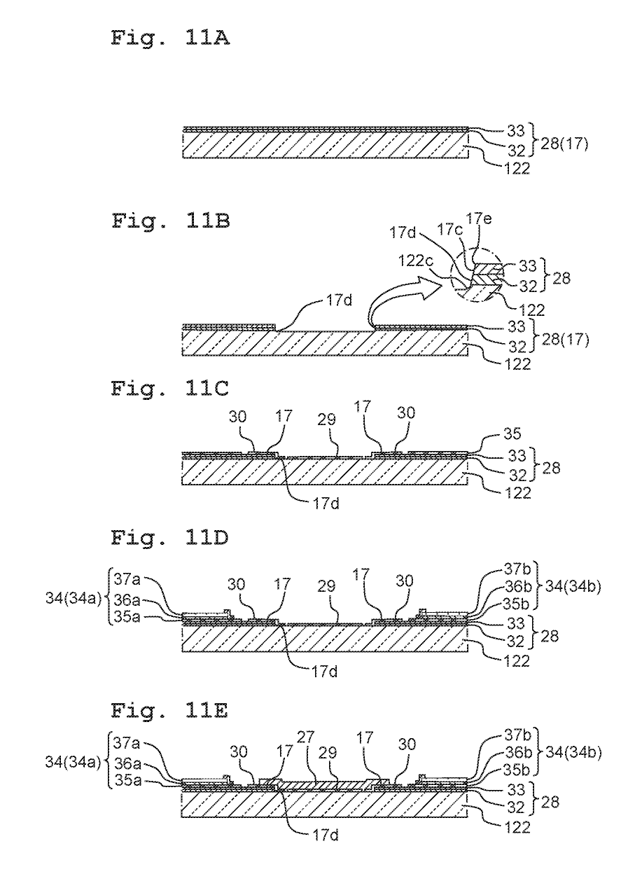

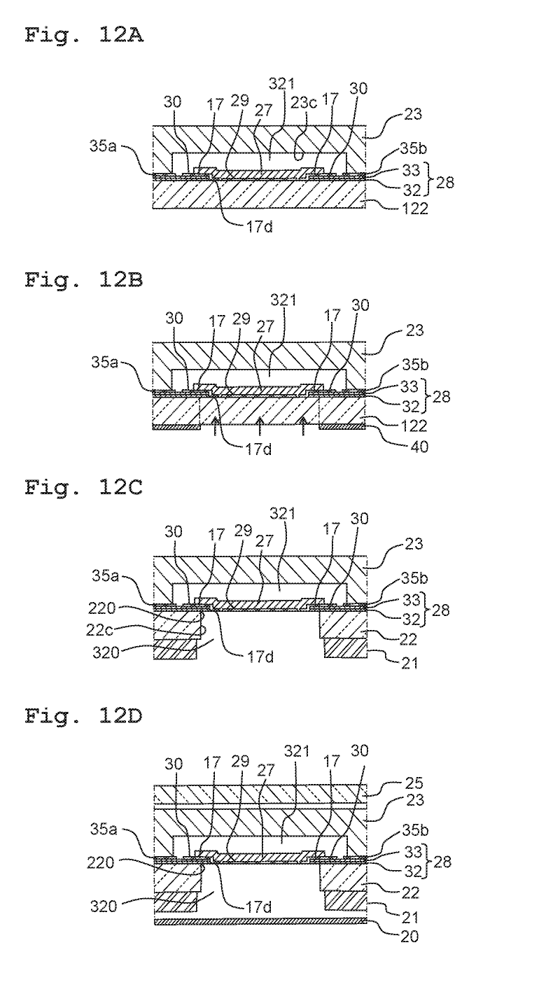

Further, by forming the film 29 on the surface of the damper film 27, in wet-etching a silicon (Si) substrate 122 for forming the substrate 22 (see FIGS. 11D and 12B), it is possible to protect the damper film 27 from the etching liquid, thereby protecting the damper film 27 from being damaged by the etching liquid.

Further, because the damper film 27 has a lower elastic modulus than the elastic layers 32 and 33 on the vibration plate 28, it is possible to further improve the effect of absorbing the ink vibration as compared to the case where the damper film 27 is formed from the vibration plate 28.

<Method for Manufacturing the Ink Jet Head>

Referring to FIGS. 11A to 12D, an explanation will be made below about a manufacturing process for the ink jet head 3.

An operator first forms the elastic layer 32 and the elastic layer 33 to superimpose each other in this order on one surface of the silicon substrate 122 which is the base of the substrate 22. For example, the elastic layer 32 is formed of a SiO₂ film while the elastic layer 33 is formed of a ZrO₂ film. With that, the vibration plate 28 and the support member 17 are formed (FIG. 11A).

Then, a pattern mask is arranged on the vibration plate 28 and the support member 17. For example, the vibration plate 28 and the support member 17 are patterned by way of dry etching to form the space 17d of the support member 17 in the position for forming the channel 320 of the substrate 122 (FIG. 11B).

As depicted here in FIG. 11B, in the patterning by way of the etching, an edge part 122c of the substrate 122 is formed in the vicinity of the periphery of the space 17d of the support member 17, as an inclined part curving gently as viewed from a direction perpendicular to the board surface of the substrate 122.

Next, the operator patterns and forms the common electrodes 35a and 35b on the vibration plate 28 by way of, for example, photolithography (FIG. 11C). On this occasion, by laying out the same material as the common electrodes 35a and 35b along the surface of the edge part 122c, the film 30 is formed to cover the vibration plate 28, the side surface 17c of the space 17d, and the edge part 122c of the substrate 122, with its surface curving gently as viewed from the direction perpendicular to the board surface of the substrate 122. Further, by laying out the aforementioned material on the surface of the substrate 122 exposed to the inside of the space 17d of the support member 17, the 400 films 29 are formed.

Then, the piezoelectric layers 36a and 36b are formed to cover part of the common electrodes 35a and 35b by way of, for example, the sol-gel method, sputtering, liquid phase method, or gas phase method. Further, on the upper surfaces of the piezoelectric layers 36a and 36b, the individual electrodes 37a and 37b and the like are patterned and formed by way of, for example, wet etching (FIG. 11D). With that, the actuator 34 is formed to have the piezoelectric elements 34a and 34b.

Next, the operator lays out a pattern mask on the upper surface of the vibration plate 28, and places an uncured resin material for forming the damper film 27 to superimpose the upper surface of the vibration plate 28, covering the space 17d of the support member 17. In this manner, by curing the placed uncured resin material, the damper film 27 is formed (FIG. 11E). Further, by virtue of this, the film 30 and the film 29 are attached to the lower surface of the damper film 27. Here, if a photoresist is used as the above resin, then it is possible to pattern and form the damper film 27 by way of, for example, photolithography.

On the other hand, the operator obtains the substrate 23 having the operation spaces 316a and 316b and the displacement space 321 by way of, for example, wet-etching another prepared silicon (Si) substrate. Thereafter, the operator superimposes (joins) the substrate 23 onto the surface of the substrate 122 provided with the vibration plate 28 (FIG. 12A).

Then, the operator thins the substrate 122. A pattern mask 40 is laid out on the surface of the substrate 122 at the other side than the vibration plate 28, to eliminate, by way of wet etching for example, the part of the substrate 122 for forming the channel 320 (FIG. 12B). By virtue of this, a through hole is formed in the substrate 122 to become the space 22c. Next, the operator forms the substrate 22 by dividing (dicing) the substrate 122 into a plurality of chips.

Here, the damper film 27 has a higher toughness than the elastic layers 32 and 33 on the vibration plate 28. Hence, even if the space 22c with a comparatively large inner diameter is formed by way of etching, it is still possible to preferably form the substrate 22 while preventing the damper film 27 from damage due to the etching.

Next, the operator obtains the substrate 21 by way of, for example, wet-etching still another prepared silicon (Si) substrate. Thereafter, the operator superimposes (joins) the substrate 21 onto the substrate 22 (FIG. 12C).

Then, the operator fits the channel member 24 to the substrate 21 and the substrate 23 and, meanwhile, imposes the IC 25 on the upper surface of the substrate 23 and superimposes (joins) the nozzle substrate 20 onto the substrate 21 (FIG. 12D). The channels 300a and 300b are formed by combining the substrate 21 and the channel member 24. With that, the ink jet head 3 is obtained.

Here, as described above, because the channel 300a and the channel 300b are formed with the channel member 24 and the other substrate 21 than the substrate 22, it is possible to suppress the width of the substrate 22 along the scanning direction. As a result, it is possible to increase the number of substrates 22 formable from one silicon substrate 122 while reducing the cost for manufacturing the substrate 22.

Further, if the vibration plate 28 doubles as the damper film 27, then it is possible to omit the process (FIG. 11B) for dry-etching the vibration plate 28 for forming the space 17d. In this manner, if the vibration plate 28 doubles as the damper film 27, then for example, only the elastic layer 33 may be eliminated by way of dry etching. In such a case, the damper film 27 is formed from the elastic layer 32.

Further, in the above embodiment, such a configuration is exemplified that the common electrodes 35a and 35b are arranged at a distance from the film 30 along the scanning direction. However, the common electrodes 35a and 35b may be formed continuous with the film 30. It is possible to pattern the common electrodes 35a and 35b and the film 30 through the same process using the same metallic material (FIG. 11C).

Further, the conveyance direction in the above embodiment is one example of the first direction. The scanning direction in the above embodiment is one example of the second direction. The vertical direction in the above embodiment is one example of the third direction.

In the above embodiment, the substrate 21 corresponds to the channel member, the pressure chamber 302a corresponds to the first pressure chamber, and the pressure chamber 302b corresponds to the second pressure chamber. Further, the channel 300a corresponds to the first common channel, the channel 300b corresponds to the second common channel, and the channel 320 corresponds to the third common channel. Further, the surface S1 corresponds to the first surface, and the surface S2 corresponds to the second surface.

Further, the end E1 corresponds to one of the first end and the second end, while the end E2 corresponds to the other of the first end and the second end. Further, the end E3 corresponds to one of the third end and the fourth end, while the end E4 corresponds to the other of the third end and the fourth end. Further, the end E9 corresponds to the third end, while the end E10 corresponds to the fourth end. Further, the end E5 corresponds to the fifth end, while the end E6 corresponds to the sixth end. Further, the end E7 corresponds to the seventh end, while the end E8 corresponds to the eighth end. Further, the substrate 23 corresponds to the second substrate.

Further, the part 17h corresponds to the first part, while the part 17i corresponds to the second part. Further, the space 17d corresponds to the second space. Further, the elastic layers 32 and 33 correspond to the first layer.

The present teaching is not limited to the above embodiment but, without departing from the true scope and the spirit of the present teaching, the configuration and method thereof may be changed, supplemented, and/or deleted. In the above embodiment, such a configuration is depicted as to arrange the damper film 27, the support member 17, and the films 29 and 30 between the two pressure chamber rows Qa and Qb. However, it is possible to apply such configuration to ink jet heads including pressure chambers included in at least one pressure chamber row, and one common channel in communication with the pressure chambers included in the one pressure chamber row.

What is claimed is:

1. A liquid jetting apparatus comprising:
first pressure chambers aligned in a first direction;
second pressure chambers aligned in the first direction and arranged at a distance from the first pressure chambers in a second direction orthogonal to the first direction;
a first common channel extending in the first direction and communicating with the first pressure chambers;
a second common channel extending in the first direction and communicating with the second pressure chambers;
a third common channel extending in the first direction and communicating with the first pressure chambers and the second pressure chambers;
a substrate having a surface parallel to the first direction and the second direction and being formed with the first pressure chambers, the second pressure chambers, and a space constituting at least part of the third common channel;
vibration plates defining upper surfaces of the first pressure chambers and the second pressure chambers;
piezoelectric elements formed to overlap with the vibration plates respectively; and
a damper film defining an upper surface of the space,
wherein the space is arranged between the first pressure chambers and the second pressure chambers in the second direction to extend in the first direction, and
the damper film covers an opening, on an upper surface side of the substrate, forming the space.

2. The liquid jetting apparatus according to claim 1, further comprising:
an integrated circuit configured to drive the piezoelectric elements; and
a wiring member having wires connecting the piezoelectric elements to the integrated circuit,
wherein contact points between terminals of the wires and terminals of the piezoelectric elements are arranged not to overlap with the space in a third direction orthogonal to the first direction and the second direction.

3. The liquid jetting apparatus according to claim 2,
wherein the substrate has a first end and a second end which are both ends in the second direction,
the piezoelectric elements include first piezoelectric elements corresponding to the first pressure chambers respectively and second piezoelectric elements corresponding to the second pressure chambers respectively,
the first pressure chambers and terminals of the first piezoelectric elements are arranged between the first end and the space in the second direction, and
the second pressure chambers and terminals of the second piezoelectric elements are arranged between the second end and the space in the second direction.

4. The liquid jetting apparatus according to claim 3,
wherein the terminals of the first piezoelectric elements are arranged between the first pressure chambers and the space in the second direction, and
the terminals of the second piezoelectric elements are arranged between the second pressure chambers and the space in the second direction.

5. The liquid jetting apparatus according to claim 2,
wherein the wiring member is a second substrate having a first surface on which the integrated circuit is mounted and a second surface which is opposite to the first surface and formed with the terminals of the wires, and
each of the wires has a part formed inside a space which penetrates the second substrate from the first surface to the second surface.

6. The liquid jetting apparatus according to claim 5, wherein the second surface of the second substrate is formed with a recess facing the damper film in the third direction.

7. The liquid jetting apparatus according to claim 1,
wherein each of the vibration plates includes a first layer, and
the liquid jetting apparatus further comprises a support member constructed of the same the same layer as the first layer and interposed between the substrate and the damper film, in a third direction orthogonal to the first direction and the second direction, to support the damper film.

8. The liquid jetting apparatus according to claim 7, wherein the damper film has a lower elastic modulus than the first layers.

9. The liquid jetting apparatus according to claim 7, wherein the damper film has a higher toughness than the first layers.

10. The liquid jetting apparatus according to claim 7, wherein the first layer is formed of an inorganic material.

11. The liquid jetting apparatus according to claim 10, wherein the damper film is formed of a resin material.

12. The liquid jetting apparatus according to claim 11, wherein the damper film is formed of photoresist.

13. The liquid jetting apparatus according to claim 7,
wherein the substrate has a first end and a second end which are both ends in the second direction,
the space has a third end and a fourth end which are both ends in the second direction,
the third end is arranged between the first end and the fourth end,
the fourth end is arranged between the third end and the second end,
the support member has:
a first part which is arranged between the first end of the substrate and the third end of the space in the second direction and interposed between the damper film and the substrate in the third direction; and
a second part which projects from the first part toward the fourth end of the space in the second direction, and
a side surface of the second part is positioned between the third end of the space and the fourth end of the space.

14. The liquid jetting apparatus according to claim 13, further comprising a film having:
a) a part A interposed between an upper surface of the second part and the damper film;
b) a part B interposed between the side surface of the second part and the damper film; and
c) a part C projecting from the part B toward the fourth end of the space in the second direction,
wherein an end of the part C is arranged between the third end of the space and the fourth end of the space in the second direction.

15. The liquid jetting apparatus according to claim 14, wherein the film is formed of the same material as an electrode included in each of the piezoelectric elements.

16. The liquid jetting apparatus according to claim 7, further comprising a second space arranged in the space as viewed from the third direction,
wherein the support member includes a ring-like portion arranged to enclose the space as viewed from the third direction, a peripheral portion defining the second space, and an extending portion extending from the ring-like portion toward the peripheral portion.

17. The liquid jetting apparatus according to claim 1, further comprising at least one film stacked on a surface, of the damper film, facing the space.

18. The liquid jetting apparatus according to claim 17, wherein the film is formed of the same material as an electrode included in each of the piezoelectric elements.

19. The liquid jetting apparatus according to claim 1, further comprising a channel member defining the first common channel and the second common channel,
wherein the substrate has a first end and a second end which are both ends in the second direction,
the channel member has a third end and a fourth end which are both ends in the second direction,
the first common channel has a fifth end and a sixth end which are both ends in the second direction,
the second common channel as a seventh end and an eighth end which are both ends in the second direction,
in relation to the second direction, the fifth end, the sixth end, the seventh end, and the eighth end are arranged in this order from the third end toward the fourth end, and
the distance from the first end to the second end in the second direction is shorter than the distance from the fifth end to the eighth end in the second direction.

20. The liquid jetting apparatus according to claim 19,
wherein the channel member includes a second substrate stacked on a surface, of the substrate, opposite to the surface on which the vibration plates are arranged, and
the second substrate defines at least part of the first common channel and at least part of the second common channel.
